(19) United States
(12) Patent Application Publication
(10) Pub. No.: US 2015/0190853 A1
(43) Pub. Date: Jul. 9, 2015

(54) METHOD AND SYSTEM FOR THE RECOVERY OF WASTE AND FOR CLEANING A HYDROCARBON STORAGE TANK

(71) Applicant: Joel Ligiero Vargas Junior, Guaratingueta - SP (BR)

(72) Inventor: Joel Ligiero Vargas Junior, Guaratingueta - SP (BR)

(21) Appl. No.: 14/411,028

(22) PCT Filed: Jun. 25, 2013
(86) PCT No.: PCT/BR2013/000228

§ 371 Date: Dec. 23, 2014

(30) Foreign Application Priority Data
Jun. 26, 2012 (BR) 10 2012 015763-2

(51) Int. Cl. B08B 9/093

(52) U.S. Cl. CPC B08B 9/0933

(57) ABSTRACT

The present invention relates to a method for the recovery of waste and cleaning of a hydrocarbon storage tank, comprising:
evaluating the viscosity of a sludge existing at the bottom of the tank;
solubilizing the sludge generating solubilized hydrocarbon;
draining the solubilized hydrocarbon from inside the storage tank;
mixing the sludge remaining inside the tank with water, by means of stirring, and keeping remaining hydrocarbon and water at rest until water/hydrocarbon separation; and
removing from the tank at least one of remaining water and hydrocarbon.

The present invention also refers to a system for the recovery of waste and cleaning of a hydrocarbon storage tank.

The present invention refers to a method and system for recovery of waste and cleaning of a hydrocarbon storage tank and for waste treatment. More specifically, the present invention refers to a method and system for removal and recovery of sludge formed on the inner portion of storage tanks, through the treatment of the waste extracted from the tank.

### DESCRIPTION OF THE PRIOR ART

Currently, oil industries utilize storage tanks to store crude oil and its derivatives, so that, thereafter, it is processed or transported to other storage locations. These tanks have very large dimensions in order to store a large amount of product.

Over time, such storage tanks accumulate inside, sediments composed of chains of heavy hydrocarbons, water and solids, also called “sludge”. In case the sludge is not periodically removed, there is a decrease in the storage capacity of the tank. In addition, excess sludge can compromise the quality of oil and its derivatives.

Before starting sludge removal, it is necessary to open the tank and measure its level of explosiveness, which depends on the content of hydrocarbons in its atmosphere. If the level of explosiveness is still high, it is necessary to blow air inside for several days, to reduce the hydrocarbon content.

Usually, sludge removal is done, normally, manually, in which hoes and scrapers are used, more precisely, shovels, buckets and, if necessary, wheelbarrows are used, all these equipment being operated by people who need to enter the tank, which internal environment is toxic and slippery, with high accident risks. The sludge manually removed is placed in drums and sent for incineration. It should be noted that, depending on the size of the tank, five thousand drums for sludge removal may be used. Due to the large amount of sludge stored inside the tank, this removal process is quite long, and may last for several months, during which the tank goes out of use.

In addition, the sludge incinerated consists of wasted hydrocarbon, which, if it were subjected to a proper recovery treatment, it could be reused and form value-added material.

After the sludge removal, a thin cleaning and a tank degassing is carried out, it being also made manually, with the use of solvents, soap and cloths, thus exposing the human labor to the same risks mentioned in the step of sludge removal.

Degassing is carried out in order to remove hydrocarbon vapors present inside the tank, and consists of opening every door in the tank and blow air, through fans, into its inner part, in order to renew the internal air.

This cleaning technique requires the use of a large amount of labor work, since workers must work under job rotation schemes inside the tank. The worker remains around twenty minutes inside the tank working and about forty minutes outside, in order to prevent poisoning due to the gases released by the petroleum product.

Another drawback of this technique is the fact that workers are exposed to a high risk of accidents and contamination inside the tank.

Furthermore, this technique has low efficiency, since depending on the size of the tank and of the existing sludge, the cleaning work takes 8 to 12 months, which causes a high maintenance cost, since it uses a large amount of labor work, around 40 people, plus the fact that the equipment will be out of operation for a long period.

Thus, there is no system in the state of the art that removes the sludge from inside the tank and recovers it, or degas the storage tanks, in a quick and efficient manner.

Finally, another drawback is that all the sludge that gets accumulated inside the tank consists of raw material with high added value that is missed, since it is incinerated after its removal, a measure that causes environmental harm. This material could be recovered and sold, making the process even more profitable and environmentally-friendly. However, the recovery of this accumulated sludge in the tank is not simple, since it consists of heavy hydrocarbons and solids which processing is difficult.

### OBJECTS OF THE INVENTION

A first object of the invention is to provide a method of recovering waste and cleaning of a hydrocarbon storage tank which minimize the environmental impact and generate added-value material, causing the process to be cost effective.

A second object of the invention is to provide a method of recovering waste and cleaning of a hydrocarbon storage tank which is performed quickly and efficiently.

A third object of the invention is to provide a method of waste recovery and cleaning of a storage tank, without the need of admission of workers inside, preserving workers' health and integrity, and which exempt a degassing operation of the tank in the traditional prior art pattern, by means of blowing air into the tank.

A fourth object of the present invention is to provide a method of waste recovery and cleaning of a storage tank which do not use chemicals for cleaning the tank.

A fifth object of the present invention is to provide the use of a skimmer in the method of recovering waste and cleaning of the storage tank.

### BRIEF DESCRIPTION OF THE INVENTION

The objects are achieved through a method for the recovery of waste and cleaning of a hydrocarbon storage tank, which comprises the following steps:
a. evaluating the viscosity of a hydrocarbon sludge existing at the bottom of the tank (1);
in the presence of heavy hydrocarbons, performing the following steps:
   solubilizing the sludge generating solubilized hydrocarbon;
   draining the solubilized hydrocarbon from inside the storage tank;
after draining the solubilized hydrocarbon or in the absence of heavy hydrocarbons in the sludge, proceeding to step b;
b. mixing the hydrocarbon remaining inside the tank (1) with water, by means of stirring, and keeping at rest until water/hydrocarbon separation;
c. removing from the tank at least one of remaining water and hydrocarbon.

The step of removing the remaining hydrocarbon from the tank can be carried out by at least one of a skimmer arranged inside the tank in contact with the surface of the water/hydrocarbon mixture and a hose in contact with the surface of the water/hydrocarbon mixture.

The water removed from the tank can be still sent to a water/hydrocarbon separator and the water is withdrawn from the water/hydrocarbon separator with a hydrocarbon content below 15 ppm.

The step of solubilizing the sludge comprises, preferably, to insert a solvent in the tank to solubilize the sludge, the solvent being heated to a temperature between 30° C. and 90° C. The stirring carried out in the step of mixing the hydrocarbon remaining inside the tank with water is preferably carried out with water heated to a temperature between 30° C. and 90° C.

The method may further comprise the step of inserting in the tank a flow contention barrier on the surface of the sludge in a direction approximately transverse to the direction of the hydrocarbon mixture and forming a hydrocarbon drainage zone by means of hydrocarbon buildup in a region adjacent to one of the faces of the barrier. Furthermore, the method may also have the steps of sending the hydrocarbon removed from the tank to a temporary hydrocarbon tank and draining water separated from the hydrocarbon in the temporary tank to a water/hydrocarbon separator.

The objects of the invention are also achieved by a system for cleaning a hydrocarbon storage tank, comprising:

a hydrocarbon storage tank with at least one manhole and at least one drain, the tank containing hydrocarbon sludge,
a mixing device for mixing the sludge within the tank with a solvent or water, thereby generating solubilized hydrocarbon;
an external pump for stirring the contents inside the tank and for sucking the tank contents,
at least one heating device to heat the contents of the tank.

The system is preferably adapted to perform the method described herein.

The system may also present a flow contention barrier in contact with the surface of the tank contents, in a direction approximately transverse to the direction of the hydrocarbon mixture, thereby forming a hydrocarbon drainage zone adjacent to one side of the barrier.

In addition, the system preferably comprises a hydrocarbon/water separator for extracting hydrocarbon from the water removed from the tank, the separator being connected to the drain of the storage tank, and a provisional hydrocarbon tank to which the hydrocarbon extracted from the storage tank is sent, the provisional hydrocarbon tank comprising an outlet for the water separated from the hydrocarbon, the water outlet being connected to an inlet of the water/hydrocarbon separator.

A pump suction inlet is connected to a drain of the storage tank and a pump discharge outlet is connected to a storage tank manhole. In addition, at least one skimmer is disposed inside the tank in contact with the surface of the tank contents in a hydrocarbon drainage zone to remove the remaining floating hydrocarbon from the tank. The skimmer has a propulsion and control system, by means of which it is displaceable on the surface of the contents of the storage tank. A hose can be arranged in contact with the surface of the tank contents in a hydrocarbon drainage zone to remove the remaining floating hydrocarbon from the tank.

### BRIEF DESCRIPTION OF THE DRAWINGS

FIG. 1—is a perspective view of a system for the recovery of waste and cleaning of a hydrocarbon storage tank 1 according to the invention, forming a closed circulation circuit.

FIG. 2—is a perspective view of a fluid storage tank 1 of the system shown in FIG. 1, with an external heat exchanger 6, forming a closed heating circuit.

FIG. 3—is a front view of a floating skimmer 7 over a layer of water 8 and hydrocarbon 9 used in the system shown in FIG. 1.

FIG. 4—is a front view of a fluid storage tank 1 with a floating skimmer assembly 7 inside the tank. Externally, there exists the hydrocarbon recovery pump 10 and the provisional hydrocarbon tank 11.

FIG. 5—shows a front view of a fluid storage tank 1 with a water drain pump 14, an external water/hydrocarbon separator device 12, connected to a drain 5, with discharge to a rainwater channel 13 and provisional hydrocarbon tank 11.

FIG. 6—is an internal upper view of the storage tank of the system according to the invention, showing a contention barrier 16 which forms a solubilized hydrocarbon accumulation region 18 on the surface of the tank contents.

### DETAILED DESCRIPTION OF THE DRAWINGS

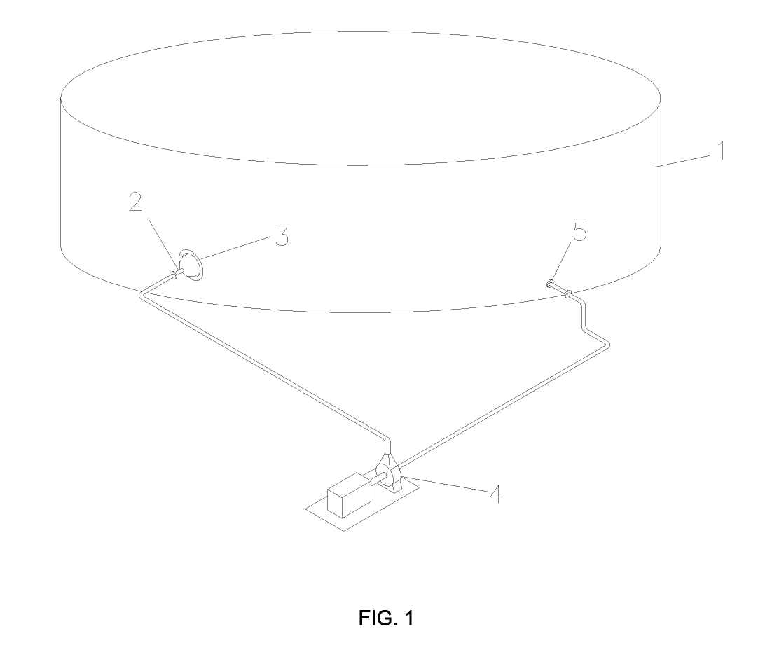

FIG. 1 illustrates a system for the recovery of waste and cleaning of a hydrocarbon storage tank according to the invention, comprising a storage tank 1 equipped with at least one manhole 3, a mixing device 2, a pump 4 and at least one drain 5. Inside the storage tank 1 there are light and heavy hydrocarbons, also called sludge 9.

The storage tank 1 of the system according to the invention is provided with a plurality of legs 15 disposed inside of it extending upwards, which serve to support the floating roof of the tank.

To perform the method for the recovery of waste and cleaning of the hydrocarbon storage tank of the present invention inside the storage tank 1, that is, to remove sludge from inside the storage tank 1, one should perform, essentially, the following steps:
a. evaluating the viscosity of a hydrocarbon sludge existing at the bottom of the tank 1;
in the presence of heavy hydrocarbons, performing the following steps:
   solubilizing the sludge generating solubilized hydrocarbon;
   draining the solubilized hydrocarbon from inside the storage tank 1;
after draining the solubilized hydrocarbon or in the absence of heavy hydrocarbons in the sludge, proceeding to step b;
b. mixing the hydrocarbon remaining inside the tank 1 with water, by means of stirring, and keeping at rest until water/hydrocarbon separation;
c. removing from the tank at least one of remaining water and hydrocarbon.

Preferably, initially the viscosity of the sludge existing inside tank 1 is assessed, that is, if the sludge can be suctioned by an external pump 4.

The sludge can be found in two different states:
Chains of light hydrocarbons (fluid), and its viscosity is between 1 cP and 100 cP;
Chains of heavy hydrocarbons (viscous, jelly or paraffin), and its viscosity is between 100 cP to 10,000 cP. In case the sludge is evaluated as a chain of light hydrocarbons, it can be suctioned by pump 4, without any damage to the suction system.

In case the sludge contains a chain of heavy hydrocarbons, one should perform a process of solubilization of the sludge, generating solubilized hydrocarbon. In a preferred embodiment of the invention, solubilization is carried out by applying a solvent to the inner part of tank 1.

More precisely, the solvent is circulated in the interior of tank 1 by at least one pump 4, which performs stirring of the contents inside tank 1. It should be noted that the volume of solvent inside the tank 1 must be sufficient to allow operation of pump 4 installed in the outer portion of tank 1. Preferably, the solvent is added to the tank up to a height above the level of the manhole in order to dissipate static energy of mixing device 2.

It should also be noted that the solvent should be circulated within the tank, in highly vigorous manner; otherwise stirring will not be sufficient to solubilize the sludge. On account of this, conventional stirrers installed inside the tank, whether electric or jet, are not suitable for solubilization of the sludge, since their objective is only the homogenization of the stored product.

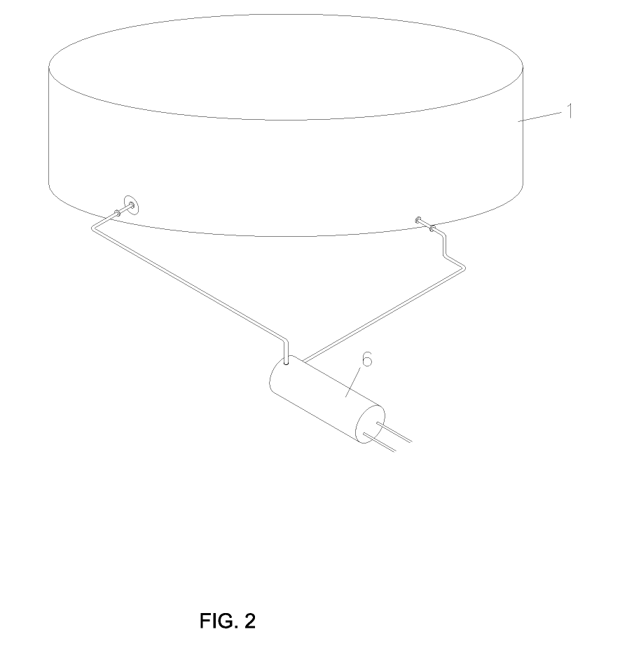

Preferably, the solvent circulated within tank 1 must be heated at temperatures between 30° C. and 90° C. Heating is performed by a heating device which may be a built-in tank heating coil 1 or a heat exchanger 6 external to the tank, as shown in FIG. 2.

Preferably, stirring should be carried out for at least 48 hours.

At least one drain 5 is located on the side of tank 1, more precisely, in preexisting drains or making holes on the side of tank 1. The drains are preferably located at heights lower than manhole 3, since they are used for extracting water separated from the hydrocarbon, which, after separation, is located below the hydrocarbon.

The discharge point of pump 4, located in manhole 3 shall be restricted on entering tank 1 by decreasing the diameter of the discharge tube. Thus, the pressure required by the system is maintained, which provides a laminar flow and directs high-impact energy to the sludge in order to solubilize it.

The pump is composed, preferably, of at least a 298.2 kW (400 HP) motor, with minimum pressure of 517.1 kPa (75 psi) and a minimum flow rate of 700 m3/h (0.1944 m3/s).

The suction inlet of the pump should be located in a drain 5 of the tank and the discharge outlet is located in manhole 3, characterizing a closed circulation system.

In one alternative embodiment, stirring of the sludge is carried out by an articulated cannon 2 positioned on manhole 3, as shown in FIG. 1.

The articulated cannon 2 works as a mixing device and performs horizontal and vertical movement. When in operation, the articulated cannon 2 is moved horizontally by one degree every 30 minutes, totaling a sweep of at least 140°. Upon completion of a horizontal cycle, that is, after moving at least 140°, the articulated cannon 2 is lifted vertically by one degree, by repeating, again, the horizontal movement. This movement of the cannon generates a circulating flow in a particular direction inside the tank.

The articulated cannon must be raised vertically from −20° to +10°, with respect to the horizontal.

The solvent used in the solubilization process is, preferably, the fluid itself stored inside tank 1 (oil), however, other fluids may be used as solvents, for example, LCO (Light Cycle Oil), diesel oil, kerosene, naphtha, etc.

After this, one can monitor the solubilization process by means of portable viscometers, for example, by picking up samples of fluid present inside tank 1 every 30 (thirty) minutes. The samples are measured by the portable viscometer and, if there is no change in viscosity of three samples measured successively, the desired solubilization level is reached and the solubilization process is suspended.

It should be noted that the collection of the samples is preferably performed at least every 30 minutes. In case it is carried out prior to this time, the variation of viscosity of the sludge will suffer minor variations, which is not desired during its monitoring.

Additionally, it should be noted that the time required for solubilization varies between 48 hours and 120 hours.

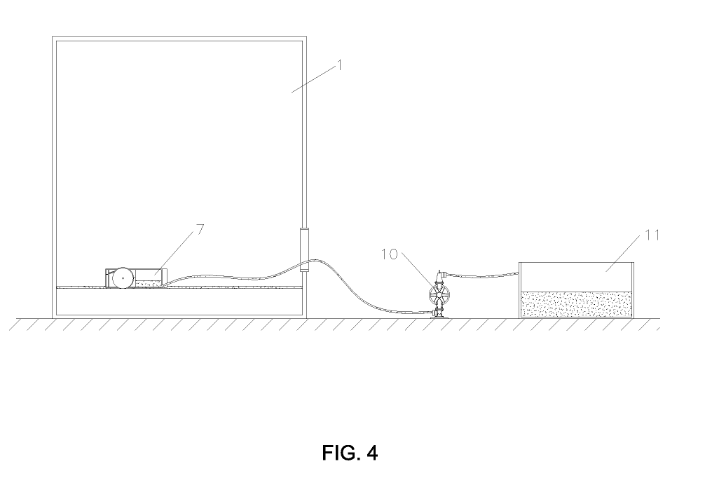

After the suspension of the solubilization process, the existing solubilized hydrocarbon inside the tank is drained to a provisional hydrocarbon tank 11, as shown in FIG. 4, thereby allowing the continuation of the process. This hydrocarbon recovered from the waste in the tank, following the treatment steps described herein, can be reused, because it has potential energy and commercial value.

After draining of the solubilized hydrocarbon, there still exist remnants of sludge within tank 1 which can be recovered. These remnants of sludge are mixed with water by means of vigorous stirring. It should be noted that the volume of water 8 inside tank 1 shall be 30% of the remaining volume of sludge, and it can be increased to allow full operation of pump 4, that is, the volume of water will depend on the suction capacity of pump 4. Preferably, water is added to the tank up to a height above the level of the manhole, in order to dissipate static energy of the cannon.

It is worth mentioning that the water mixed with the remaining sludge is not salt water, allowing its subsequent disposal in treatment plants and rainwater systems, or its reuse without impacts on the environment, after extraction of the remnants of sludge/oil mixed with it.

Preferably, the water mixed inside tank 1 must be heated to temperatures between 30° C. and 90° C., and preferably between 70° C. and 90° C., however, the final heating temperature depends on the hydrocarbon. Heating may be accomplished through an internal heating coil of tank 1 or through an external heat exchanger 6, as illustrated in FIG. 2. Heating of water is necessary, so that it is possible to dissolve paraffin oil contained in the sludge.

The water should be mixed with the sludge by means of external pump 4 and by means of articulated cannon 2 for at least 48 hours, by means of vigorous stirring. It should be noted that the implementation of the mixture of water with sludge is carried out analogously to the application of the solvent in the solubilization process.

Once the water/hydrocarbon mixing time is concluded, the mixture should be left at rest for at least 4 hours inside the tank, so that there is the separation of the water/hydrocarbon phases. Since water 8 will be at the bottom of tank 1, free of hydrocarbon 9, consequently, hydrocarbon 9 will float.

After the waiting time of water/sludge separation, the contents of the tank is drained until it is below manhole 3. Drainage occurs through said drain 5 and the drained material consists essentially of water, already separated from the hydrocarbon after the resting step, which will be recovered to be reused. Then, manhole 3 is opened and a flow contention barrier 16 is installed within the tank, barrier which is designed to generate an accumulation of an thick layer of oil 18 in the vicinity of one of manholes 3 of the tank, in order to facilitate drainage of the liquid hydrocarbon and/or generated oil from the dissolution of the sludge and improve the performance of the method according to the invention.

The water/sludge mixture being stirred and mixed within the tank generates a circulating current in a particular direction inside the tank. As a result, the barrier is preferably disposed within the tank in a transverse orientation, and preferably perpendicular, to the circulating flow. Thus, the circulating flow, when colliding with a face 20 of barrier 16 tends to accumulate in the region adjoining said face 20 of the barrier, forming a thick hydrocarbon/oil layer on the surface of the water/hydrocarbon mixture which makes up a drain region of hydrocarbon 18, which facilitates drainage of the hydrocarbon existing in the sludge.

Due to the formation of the thick layer of oil in the region near the barrier, the hydrocarbon accumulated and separated from the water can be drained from the tank with the aid of a skimmer 7 arranged inside the tank, and/or only through a hose or similar pipe extending from this region near the barrier to the outer part of the tank, with no need of using a skimmer at least for draining that portion of oil or sludge. The hose and/or skimmer 7 are in contact with the surface of the water/hydrocarbon mixture inside the tank, in the region of draining hydrocarbon 18, being adjacent to the contention barrier 16.

The drained hydrocarbon can be sent through the hose or with the aid of skimmer 7 directly to the provisional hydrocarbon tank 11, or any other storage container for the storing this type of product generated from the sludge. Thus, the hydrocarbon recovered from the tank waste will be stored in the provisional tank 11 or equivalent container, which may later be reused. The provisional hydrocarbon tank 11 preferably has an internal heating device for heating and maintaining the fluidity of the recovered hydrocarbon stored inside. During the period in which the hydrocarbon is stored in the provisional tank 11, there also occurs the separation of water and hydrocarbon. The separated water may be discarded or drained from an outlet of the provisional tank 11 to an input of an external water/hydrocarbon separator device 12, which will be described later, to be treated in order to reduce its hydrocarbon content, and recover it in order to allow its reuse. Barrier 16 is introduced into the tank via manhole 3 and extends from a point near the manhole toward a leg 15 inside the tank and is disposed on the surface of the liquid, which may extend totally or partially towards the bottom of the tank.

In one embodiment of the invention, said barrier 16 consists of at least a floater 19 which floats on the surface of the water/sludge mixture, which may also have a barrier element which is attached to the floater and immersed in the water/hydrocarbon mixture, extending towards the bottom of the tank, forming a kind of skirt. Buoys with an oblong format, or a plurality of interconnected buoys that are capable of supporting the barrier element, can be used as floaters 19, for example. And as a barrier element (not shown), one may use, for example, a canvas, any type of fabric, including, PVC, or even a metal or plastic plate that provides resistance against the flow of the water/sludge mixture circulating within the tank. The barrier element extends towards the bottom of the tank and has a length such that it helps to provide a greater accumulation of the sludge/water mixture near one of the faces 20 of the barrier element and a manhole. However, floater 19 alone may now be able to provide the effect of accumulation of the water/sludge mixture on the surface of the tank, so that it can be drained from inside the tank with the aid of the skimmer, or hose, without the need of the barrier.

In another embodiment of the invention shown in FIG. 7, the contention barrier 16 consists of a plurality of floaters 19 essentially connected to each other forming a row of floats. In the middle portion of this row of floaters skimmer 7 is coupled, which can get stuck on the barrier between two floaters, or even attached to face 20 of the contention barrier on which the circulating flow of the tank collides, thereby forming the buildup of the thick layer of oil.

Regardless of its constitution, contention barrier 16 should be disposed within the tank in a position that allows the buildup of the oil layer close to one of its faces 20, which the circulating flow collides with, and one of the manholes.

A possible way to keep the barrier in proper position is securing it or tying it between the manhole and one of the legs 15 of the tank. This fixation of the barrier on leg 15 of the tank can be made by means of a cable, for example a nylon rope, attached to one end of the buoy and to leg 15 of the manhole. The fixation of this cable to the leg of the tank is, preferably, made with the aid of a remotely controlled device and able to navigate on the water/sludge mixture, for example, a remote control controlled boat. The cable tied to the end of the barrier is also stuck with its other end to the boat, which is then controlled to navigate toward a leg 15 of the tank and pass around it, returning by the opposite side of the leg 15 and pulling the end of the cable to a fixation point, which may be the manhole.

Other ways to keep the contention barrier 16 in its proper position may also be used. In an alternative manner, the contention barrier 16 is provided with at least one guide element, by means of which it can be guided and displaced, as well as held in position inside the tank. According to this alternative embodiment, a rod can be used as the guide element. The rod is attached to the contention barrier 16 and extends at least to the manhole, so that by manipulating the rod from the manhole, the position of the barrier 16 is set, and it is even possible to keep the rod in a fixed position, thereby also retaining the contention barrier 16 in a fixed position. According to this embodiment of the invention, it is necessary that barrier 16 is provided with stiffness enough to be guided by this rod. In addition, the rod must be fixed to the portion of the barrier opposite the end which is fixed to the manhole in order to be able to set its position within the tank.

Alternatively, barrier 16 is provided with two guide elements, both fixed to the portion of the barrier opposite the end disposed near the manhole, so that each of the guide elements extends to the manhole by a different side of the contention barrier. The guide elements may, in this case, be cables, nylon threads or elements of greater stiffness, such as wires or rods, fixed on the end of barrier 16. In this case, barrier 16 does not need to be completely rigid, so that its position is adjusted by the guide elements, because the controlled traction of these guide elements from both sides of barrier 16 allows adjustment of the position of barrier 16, as well as the maintenance of barrier 16 in a substantially fixed position, to form the accumulation of oil in one of its sides.

After accommodation of the contention barrier 16, inside tank 1, one skimmer 7, at least, is placed for removal of the floating remaining hydrocarbon 9, so that the skimmer is located near the barrier zone 16 where the accumulation oil or floating sludge will be formed.

Skimmer 7 is equipped with a notch-shaped roller, used to collect the floating hydrocarbon 9. It should be noted that other types of rollers or even skimmers may be used, since for each viscosity there is a type of roller or suitable skimmer.

Furthermore, skimmer 7 can be provided with a propeller propulsion system or other means, being controlled, preferably, by a remote control; however, other types of control can be used, for example, ropes and pulleys.

Through this system of propulsion and control, skimmer 7 is displaced to the points where there is concentration of floating hydrocarbon 9 within storage tank 1, on the surface of the tank contents. Activation of skimmer 7 may be mechanical, hydraulic, pneumatic or electric.

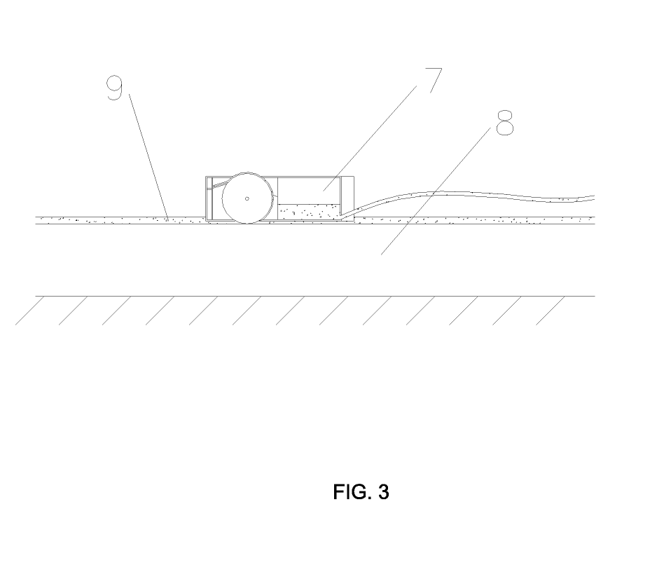

As can be seen in FIG. 3, skimmer 7 is on the layer of water 8 by collecting only the layer of hydrocarbon 9. The formation of an accumulation of floating hydrocarbon or oil near barrier 16, therefore, improves the performance of the skimmer which can drain an increased amount of hydrocarbon. Hydrocarbon 9 collected by skimmer 7 is pumped into a hydrocarbon provisional tank 11, located on the outer portion of tank 1, by means of a hydrocarbon recovery pump 10, as illustrated in FIG. 4.

It should be noted that the skimmer must operate until the hydrocarbons content in wastewater is at most 1%.

The remaining water inside tank 1 is drained by means of the water drain pump 14. For environmental reasons, the drained water should contain a maximum of 15 ppm of hydrocarbon content, and this amount may vary up or down, according to local regulations for water disposal.

If the hydrocarbon content present in the drained water is less than or equal to 15 ppm, this water is regarded as recovered and can be discharged directly into the rainwater channels 13, without the risk of environmental contamination.

If there are environmental requirements to reduce the hydrocarbon content, the drained water must be previously recovered through treatment.

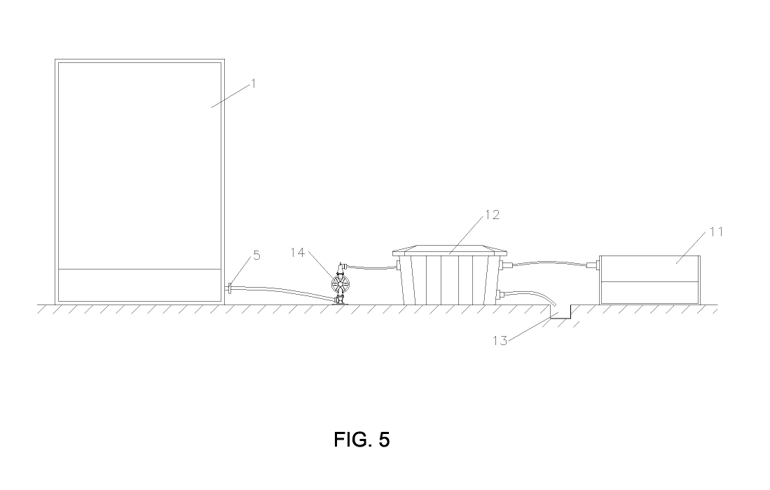

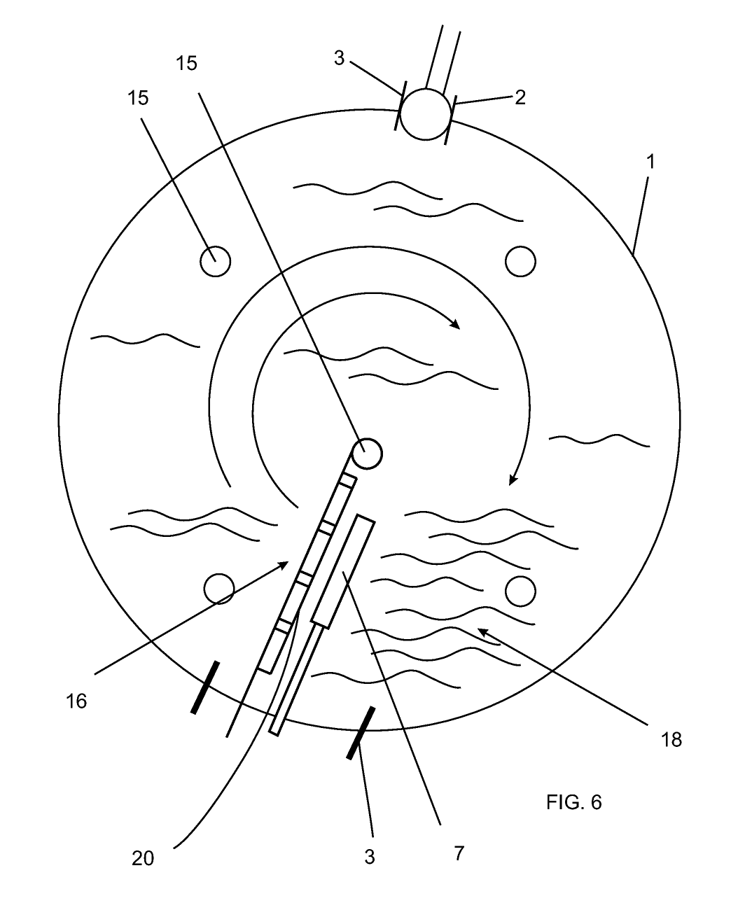

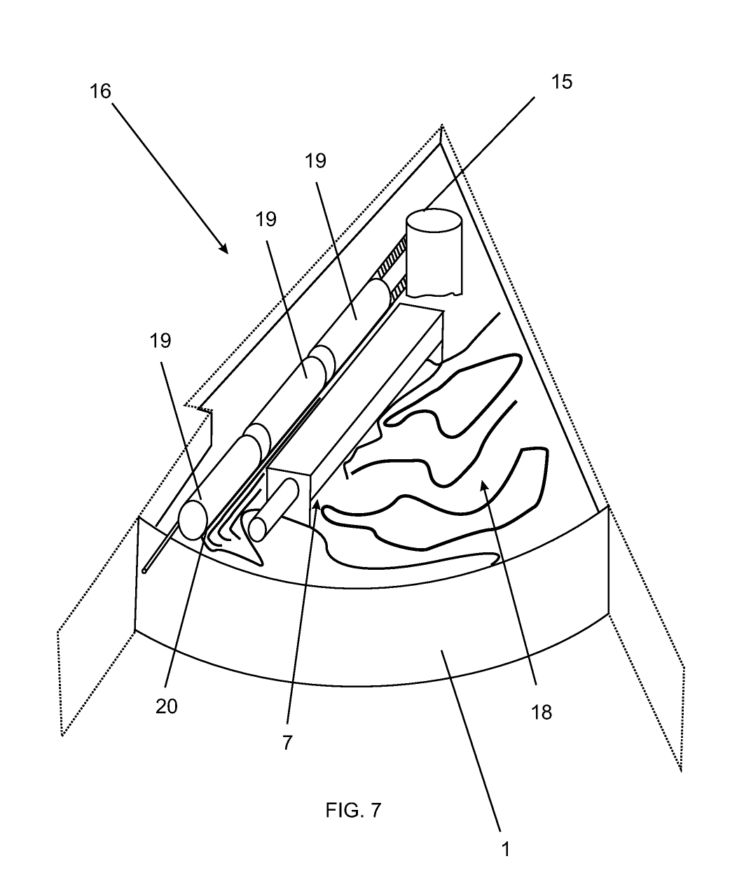

The treatment for water recovery occurs through an external water/hydrocarbon separator device 12 shown in FIG. 5, which the water drawn from storage tank 1 is sent to. The separator is, therefore, directly or indirectly connected with drain 5 of the storage tank through which water is drained from the tank. The water treatment consists of draining the remaining water inside tank 1 directly into the separator device 12, which aims to separate the water from hydrocarbon 9. After treatment in the separator device, the recovered water is disposed in rainwater channels 13 and hydrocarbon 9 is drained into provisional hydrocarbon tank 11, as shown in FIG. 5.

The provisional hydrocarbon tank 11, which the hydrocarbon extracted from the storage tank is sent to, may also have a water outlet connected to the water/hydrocarbon separator 12 inlet, so that the water separated from the hydrocarbon in this provisional hydrocarbon 11 is also treated and recovered in the separator.

It is worth mentioning that the water discharged into the channels must have a hydrocarbon content less than 15 ppm.

The external water/hydrocarbon separator device 12 is preferably a container provided with a series of barriers through which the drained water circulates, which help to separate the oil from the water which tends to accumulate at the bottom of the separator device 12. In addition, the separator device has at least one oleophilic coalescing plate which stimulates the coalescence among the hydrocarbon particles dispersed in the water, causing them to move to the surface of the liquid. This at least one coalescing plate is, preferably, disposed near the inlet of the oil separator device. This separator device is able to eliminate a large amount of oil particles in water, which can generate reclaimed water with oil concentration of about 15 ppm, which is regarded as clean water. At the same time, that way one can achieve a greater recovery of oil which consists of added-value matter.

However, other types of separator may be used, as, for example, by means of a flotation separator.

Furthermore, external water/hydrocarbon separator device 12 must allow a discharge rate of, at least 20 m3/h.

In one alternative embodiment, skimmer 7 can be used for cleaning a tank of liquids in general (not shown) such as petroleum, oils, etc.

As can be seen, the system according to the invention is adapted to perform the steps of the method for the recovery of waste and cleaning of a hydrocarbon storage tank described herein”.

One advantage offered by the invention is the fact that it does not employ chemicals, whether degreaser, surfactant or emulsifier, for cleaning the tank. These chemicals hinder the biological treatment of the remaining water and may cause damage to effluent treatment systems. Furthermore, the use of chemicals, normally, makes the cost of cleaning unfeasible, since the large tank would require a large volume of products, associated with a high cost of waste water treatment.

Another advantage of this method and system is the fact that only 45 days are necessary for carrying out cleaning of the tank along with the recovery of waste, and only four laborers to work on the outside of the tank as opposed to 8 to 12 months required by the prior art methods, and a large amount of human labor still subjected to risk of intoxication.

Another advantage presented by this method and system consists in the fact that degassing of the tank by blowing air into it is not necessary, since the sludge that generates toxic gases is almost all taken from the inside of the tank, without requiring employees working inside. Furthermore, when the tank is filled with heated water, which will be mixed with the remaining sludge, it is generated water vapor that assists in cleaning the tank and which, moreover, is mixed with the hydrocarbon vapors in the tank atmosphere, thus performing its degassing. This way, the tank is completely degassed and its level of explosiveness becomes zero, thus eliminating risks of intoxication and explosion.

Since most of the sludge is extracted and the tank is completely degassed by the process described herein, a person may immediately enter the tank without the risk of intoxication, only to remove the remainder of solid residue that was left inside.

Once the solid waste resulting from this process are degassed and decontaminated, it may be thrown away in landfills, without causing harm to the environment. In addition, the oil that is extracted from the sludge after dissolution in water is completely recycled, rather than being discarded and burnt.

Thus, a method for the recovery of waste and cleaning of a storage tank by using a skimmer is achieved, and which is carried out quickly and efficiently, and that does not use chemicals for cleaning the tank.

Also, a method for the recovery of waste and cleaning of a storage tank is achieved, in which the entry of workers inside the tank is not required, and has a low waste generation, which minimizes the environmental impact. After examples of preferred embodiments have been described, it should be understood that the scope of the present invention encompasses other possible embodiments and is limited only by the content of the appended claims, which include their possible equivalents.

1. A method for the recovery of waste and cleaning of a hydrocarbon storage tank, comprising:
evaluating the viscosity of a hydrocarbon sludge existing at the bottom of the tank;
solubilizing the sludge generating solubilized hydrocarbon;
draining the solubilized hydrocarbon from inside the storage tank;
mixing the remaining hydrocarbon inside the tank with water, by means of stirring, and keeping the remaining hydrocarbon and water at rest until water/hydrocarbon separation; and
removing from the tank at least one of remaining water and hydrocarbon.

2. The method according to claim 1, wherein the step of removing the remaining hydrocarbon from the tank is carried out by at least one of a skimmer arranged inside the tank in contact with the surface of the water/hydrocarbon mixture and a hose in contact with the surface of the water/hydrocarbon mixture.

3. The method according to claim 1, wherein the water removed from the tank is sent to a water/hydrocarbon separator, and the water is withdrawn from the water/hydrocarbon separator with hydrocarbon content below 15 ppm.

4. The method according to claim 1, wherein solubilizing the sludge comprises inserting a solvent in the tank to solubilize the sludge, the solvent being heated to a temperature between 30° C. and 90° C.

5. The method according to claim 1, wherein the stirring of the remaining hydrocarbon inside the tank with water is carried out at temperature between 30° C. and 90° C.

6. The method according to claim 1, wherein it comprises inserting in the tank a flow contention barrier on the surface of the sludge in a direction approximately transverse to the direction of the hydrocarbon mixture and forming a drain region of a hydrocarbon by means of hydrocarbon buildup in a region adjacent to one of the faces of the barrier.

7. The method according to claim 1, comprising sending the hydrocarbon removed from the tank to a provisional hydrocarbon tank and draining water separated from the hydrocarbon in the temporary tank to a water/hydrocarbon separator.

8. A system for cleaning a hydrocarbon storage tank and for treating waste, comprising:
a hydrocarbon storage tank with at least one manhole and at least one drain, the tank containing a hydrocarbon sludge;
a mixing device for mixing the sludge within the tank with a solvent or water, generating a solubilized hydrocarbon;
an external pump for stirring the contents inside the tank and for sucking the tank contents; and
at least one heating device to heat the contents of the tank.

9. The system according to claim 8, wherein the system comprising a flow contention barrier in contact with the surface of the tank contents, in a direction approximately transverse to the direction of the hydrocarbon mixture, forming a drain region of a hydrocarbon adjacent to one of the faces of the barrier.

10. The system according to claim 8, further comprising a water/hydrocarbon separator for extracting the hydrocarbon from the water withdrawn from the tank, the separator being connected to the drain of the storage tank.

11. The system according to the claim 10, further comprising a provisional hydrocarbon tank to which the hydrocarbon withdrawn from the storage tank is sent, the provisional hydrocarbon tank comprising an outlet for water separated from the hydrocarbon, the water outlet being connected to a water/hydrocarbon separator inlet.

12. The system according to claim 8, wherein a pump suction inlet is connected to a drain of the storage tank and a pump discharge outlet is connected to a storage tank manhole of the storage tank.

13. The system according to claim 8, further comprising at least one skimmer disposed inside the tank in contact with the surface of the tank contents in a drain region of hydrocarbon, to remove the remaining floating hydrocarbon from the tank.

14. The system according to claim 13, wherein the skimmer comprises a propulsion and control system, by means of which it is displaceable on the surface of the contents of the storage tank.

15. The system according to claim 8, further comprising a hose in contact with the surface of the tank contents in a drain region, to remove the remaining floating sludge from the tank.
